(19) United States
(12) Patent Application Publication
(10) Pub. No.: US 2013/0227164 A1
(43) Pub. Date: Aug. 29, 2013

(54) METHOD AND SYSTEM FOR DISTRIBUTED LAYER SEVEN TRAFFIC SHAPING AND SCHEDULING

(71) Applicants: Amit KUMAR, Bangalore (IN); Aman TEJA, Bangalore (IN); Pankaj KOTHARI, Bangalore (IN); Prashant R. KUMAR, Bangalore (IN)

(72) Inventors: Amit KUMAR, Bangalore (IN); Aman TEJA, Bangalore (IN); Pankaj KOTHARI, Bangalore (IN); Prashant R. KUMAR, Bangalore (IN)

(73) Assignee: Yahoo! Inc., Sunnyvale, CA (US)

(21) Appl. No.: 13/402,876

(22) Filed: Feb. 23, 2012

(51) Int. Cl. G06F 15/16

(52) U.S. Cl. 709/235

(57) ABSTRACT

A computer-implemented method of providing distributed layer seven traffic shaping includes receiving one or more service requests from one or more clients. The one or more service requests include network usage information associated with the one or more clients. The computer-implemented method also includes aggregating the network usage information from the one or more clients across one or more data centers. Further, the computer-implemented method includes computing a delay required for throttling the service request based on data transferred. Furthermore, the computer-implemented method includes communicating the delay to the one or more clients. Moreover, the computer-implemented method includes throttling the one or more service requests based on the delay across the one or more data centers.

### TECHNICAL FIELD

Embodiments of the disclosure relate generally, to traffic shaping and scheduling, and more specifically, to provide distributed layer seven traffic shaping and scheduling.

### BACKGROUND

A typical computer network allows clients to make requests to servers by sending data in packets. The intensity of sending the data, referred to as traffic, varies over time. For example, at times the requests can exceed a capacity provided by the computer network. In such scenarios, a bottleneck can be formed causing congestion in the computer network. Consequently, the requests are denied and in worst cases, the servers crash.

Traffic shaping is a technique which provides a means to control volume of the traffic in the computer network. Typically, a traffic shaper delays certain Transmission Control Protocol (TCP) packets based on specific criteria. The delay also refers to throttling a client request based on the specific criteria. The throttling can also be achieved by cutting off the service. Currently, the traffic shaping exists at layer four of the Transmission Control Protocol/Internet Protocol (TCP/IP) model. This allows traffic shaping to be performed only on network usage for example, data transfer, bits transfer and bandwidth limit. Further, traffic shaping is performed within a single data center. Consequently, traffic shaping is not performed globally.

Often, traffic scheduling is an additional technique required in the computer network. A specific client request can require preferential treatment over other client requests. For example, a request for spell check requires preferential treatment over a request for streaming a video. In such a case, the layer four of the TCP/IP model does not aid in traffic scheduling.

In light of the foregoing discussion, there is a need for an efficient method and system for providing a distributed layer seven traffic shaping and scheduling. Further, the method needs to be distributed so to be able to handle traffic shaping and scheduling across data centers.

### SUMMARY

The above-mentioned needs are met by a computer-implemented method, system, and computer program product for providing distributed layer seven traffic shaping and scheduling.

An example of a computer-implemented method for providing distributed layer seven traffic shaping includes receiving one or more service requests from one or more clients. The one or more service requests include network usage information associated with the one or more clients. The computer-implemented method also includes aggregating the network usage information from the one or more clients across one or more data centers. Further, the computer-implemented method includes computing a delay required for throttling the service request based on data transferred. Furthermore, the computer-implemented method includes communicating the delay to the one or more clients. Moreover, the computer-implemented method includes throttling the one or more service requests based on the delay across the one or more data centers.

Another example of a computer-implemented method for providing distributed layer seven traffic scheduling includes receiving one or more service requests from one or more clients. The one or more service requests include network usage information associated with the one or more clients. The computer-implemented method also includes classifying the network usage information. Further, the computer-implemented method includes selecting a service request from the one or more service requests. Furthermore, the computer-implemented method includes providing preferential treatment to the service request over the one or more service requests.

An example of a computer program product stored on a non-transitory computer-readable medium that when executed by a processor, performs a method for providing distributed layer seven traffic shaping includes receiving one or more service requests from one or more clients. The one or more service requests include network usage information associated with the one or more clients. The computer program product also includes aggregating the network usage information from the one or more clients across one or more data centers. Further, the computer program product includes computing a delay required for throttling the service request based on data transferred. Furthermore, the computer program product includes communicating the delay to the one or more clients. Moreover, the computer program product includes throttling the one or more service requests based on the delay across the one or more data centers.

An example of a computer program product stored on a non-transitory computer-readable medium that when executed by a processor, performs a method for providing distributed layer seven traffic scheduling includes receiving one or more service requests from one or more clients. The one or more service questions include network usage information associated with the one or more clients. The computer program produce also includes classifying the network usage information. Further, the computer program product includes selecting a service request from the one or more service requests. Furthermore, the computer program product includes providing preferential treatment to the service request over the one or more service requests.

An example of a system for providing distributed layer seven traffic shaping and scheduling includes a plurality of server devices that receives one or more service requests and that computes a delay required for throttling a service request. The system also includes a plurality of client devices in electronic communication with the server devices. Further, the system includes a resource usage database, communicatively coupled to the user interface that stores network usage information of the plurality of client devices.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a flow diagram illustrating a method for providing distributed layer seven traffic shaping, in accordance with one embodiment;

FIG. 2 is a flow diagram illustrating a method for providing distributed layer seven traffic scheduling, in accordance with another embodiment;

FIG. 3 is a block diagram illustrating a system for providing distributed layer seven traffic shaping and scheduling, in accordance with one embodiment;

FIG. 4 is a block diagram illustrating a detailed architecture of a system, in accordance with one embodiment;

FIG. 5 is a block diagram illustrating an exemplary computing device, in accordance with one embodiment; and

FIGS. 6a, 6b and 6c are exemplary illustrations for throttling (shaping) a service request from a client.

### DETAILED DESCRIPTION OF THE EMBODIMENTS

A computer-implemented method, system, and computer program product for providing distributed layer seven traffic shaping and scheduling is disclosed. The following detailed description is intended to provide example implementations to one of ordinary skill in the art, and is not intended to limit the invention to the explicit disclosure, as one or ordinary skill in the art will understand that variations can be substituted that are within the scope of the invention as described.

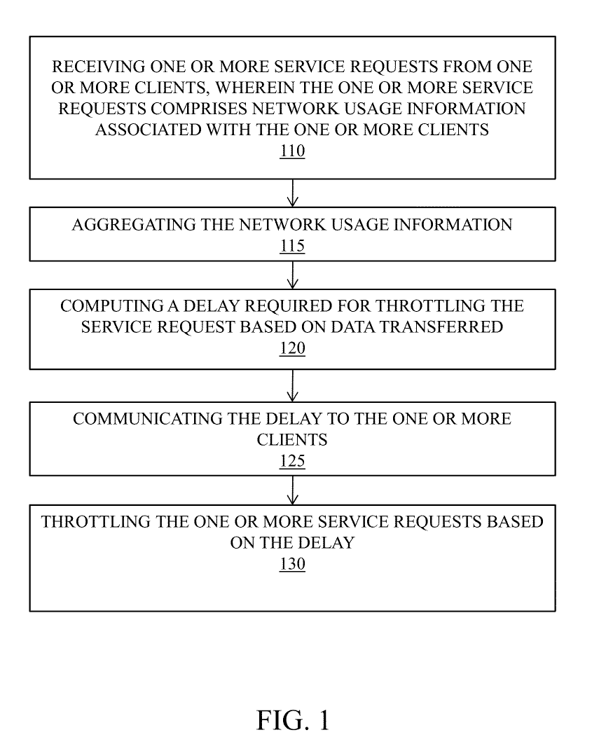

FIG. 1 is a flow diagram illustrating a method for providing distributed layer seven traffic shaping, in accordance with one embodiment.

At step 110, one or more service requests from one or more clients are received. The service requests include network usage information associated with the clients.

In some embodiments, other resource usage information can be used in place of the network usage information. Examples of the resource usage information include, but are not limited to, number of clicks on an article, number of articles and CPU consumption.

A server receives the service requests. The term “server” refers to a computing platform or computer operable to provide a service request to the clients in a network. The term “client” refers to any suitable computing device or software application operative to generate and provide the service requests. The service request can be a request for a web service, for example a request to access one or more software applications. Server locations can be herein referred to as colos or data centers. Examples of the service request include, but are not limited to, web searches, stock quotes, and other web based applications.

In one embodiment, the service requests are sent in forward channel traffic.

In an embodiment, prior to receiving one or more service requests, allowances are defined for the service requests to the clients by the server.

At step 115, the network usage information from the clients is aggregated across one or more data centers.

The data centers are distributed. The term data centers can also be referred to as server locations. For example, it may be desirable to have the server locations in one or more geographic regions. The data centers process the service requests from the clients.

In one embodiment, the data centers can communicate with each other.

The network usage information includes amount of data transferred by the client in an existing day. The network usage information corresponding to the clients is extracted. In one embodiment, the network usage information is sent by the clients to the data centers in an asynchronous manner. The server aggregates the network usage information received across the data centers.

Further, the network usage information is stored in a database by the server.

In one embodiment, forward channel traffic can be sent periodically. The forward channel traffic represents a stream of data that passes to the server. There can be a latency that delays the throttling (shaping) decision. The latency can be termed as information transmission delay. In an embodiment, the throttling can also be achieved by cutting off the service. At step 120, a delay required for throttling the service request is computed based on data transferred.

Based on the aggregated network usage information and current bandwidth usage by the clients, the server calculates the delay. In one embodiment, each of the distributed servers calculates the delay. The delay is required to throttle a particular service request based on the data transferred.

At step 125, the delay is communicated to the clients.

The delay is communicated on a separate reverse channel connection. Further, the clients are identified using the appid.

Further, the delay is stored in a database.

At step 130, the service requests are throttled based on the delay across the data centers.

One or more service requests are throttled by enforcing the delay. This enables traffic shaping across one or more data centers in the network.

Further, the throttling is performed on Layer Seven of the TCP/IP model. Layer Seven allows throttling based on any measurable resource across data centers.

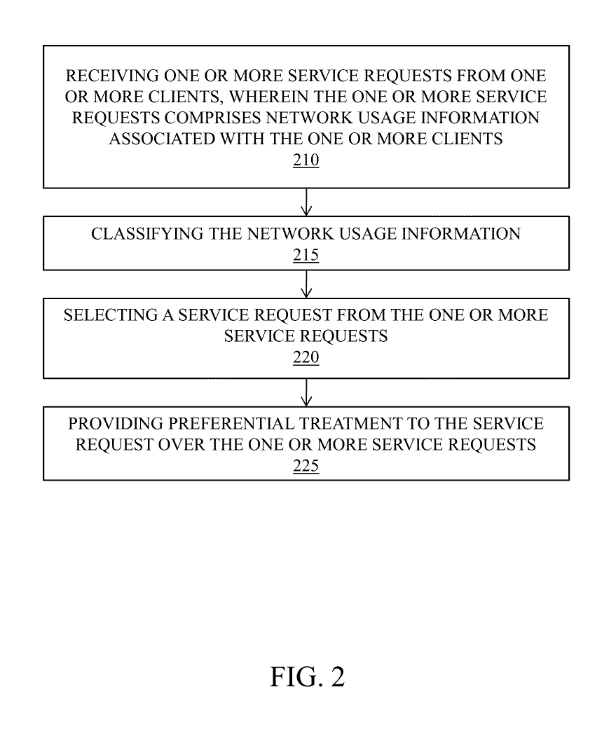

FIG. 2 is a flow diagram illustrating a method for providing distributed layer seven traffic scheduling, in accordance with another embodiment.

At step 210, one or more service requests from one or more clients are received.

A server receives the service requests. The service request can be a request for a web service, for example a request to access one or more software applications. Examples of the service request include, but are not limited to, web searches, stock quotes, and other web based applications.

Further, the service requests include network usage information associated with the clients.

In an embodiment, prior to receiving the service requests, the server defines allowances for the service requests to the clients.

At step 215, the network usage information is classified.

Classification is performed on basis of priority. For example, service request A requires preferential treatment over service request B. In such a case, the service request A can be classified as important. In one embodiment, classification is not limited to priority.

At step 220, a service request is selected from the one or more service requests.

Based on the classification, the service request which requires a preferential treatment is selected from amongst other service requests.

At step 225, preferential treatment is provided to the service request over the one or more service requests.

The preferential treatments are one of delay on the service request and prioritizing on the service request.

Consequently, traffic in the network can be scheduled accordingly.

In one embodiment, traffic in the network can be scheduled across one or more data centers. In such a scenario, the network usage information is aggregated from across one or more data centers.

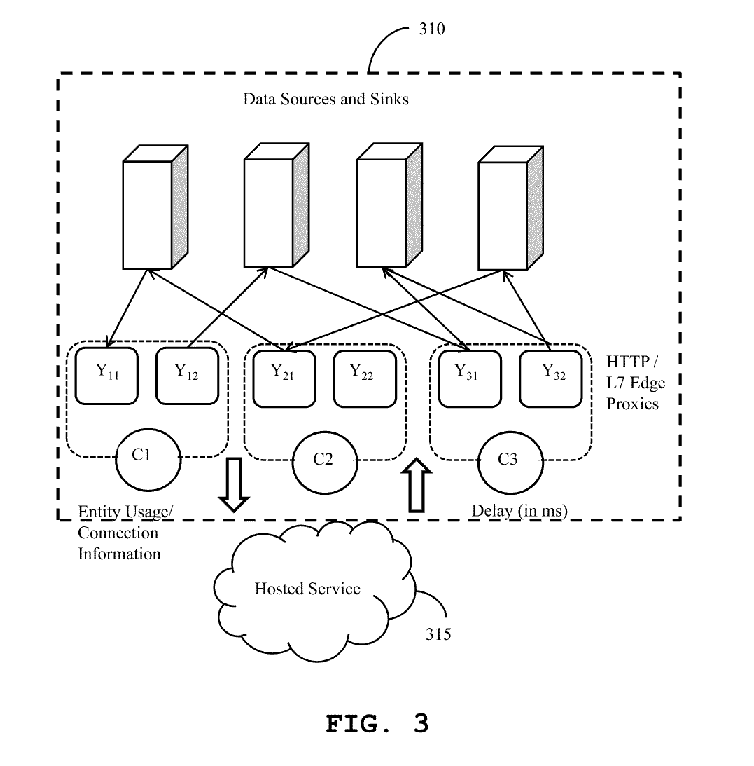

FIG. 3 is a block diagram illustrating a system for providing distributed layer seven traffic shaping and scheduling, in accordance with one embodiment.

The system consists of a two tier architecture. A first tier 310 represents Hyper Text Transfer Protocol (HTTP) Layer Seven network edge proxies. The first tier 310 receives requests from multiple clients. The edge proxies are responsible for capturing the network usage information (data transfer) and forwards the information to servers in a second tier 315. The second tier 315 represents the hosted servers. Servers include Web Traffic Management Service.

The second tier 315 aggregates the network usage information sent from the multiple clients in the first tier 310. Further, current bandwidth usage of connecting clients is computed. The aggregated data and current bandwidth are used to calculate delay. The delay is then sent back to the multiple clients.

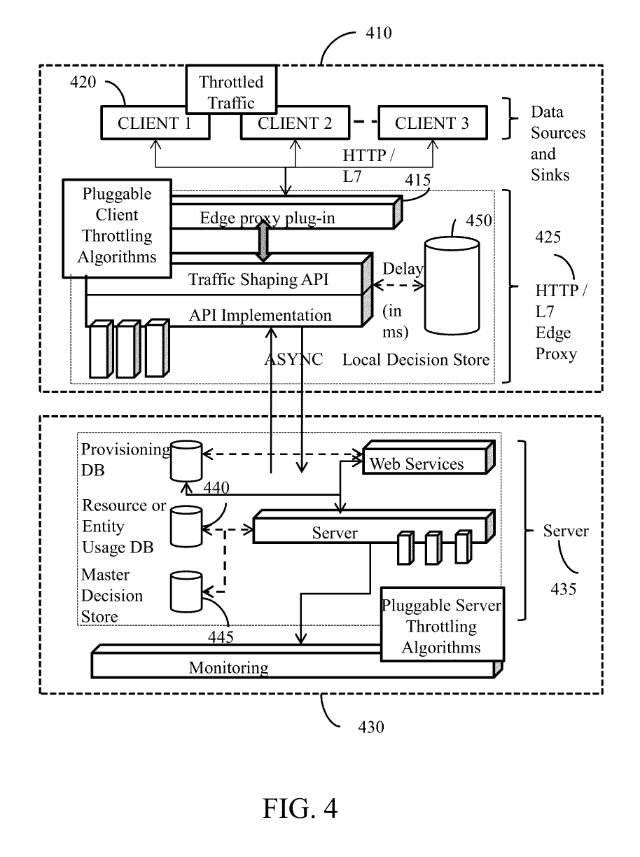

FIG. 4 is a block diagram illustrating a detailed architecture of the system, in accordance with one embodiment.

Client side 410 of the system includes an edge proxy plug-in 415 and client 420 components. When a request is received by edge proxy, data is transferred. At this point, the edge proxy plug-in 415 registers a callback with the server 430. The edge proxy 425 invokes the callback when proxy request buffers are filled over a certain capacity or when sufficient time has elapsed since the last callback. The edge proxy 425 passes the additional number of bytes in the request buffer for the HTTP transaction.

When the callback is invoked, information about the presence of additional data is sent to the server 435.

When the server 435 receives resource usage information, an appropriate traffic shaping algorithm is invoked. The resource usage information is an aggregation of the amount of data transferred by a specific client across data centers for a current time period. Further, the resource usage information is stored in a resource/entity usage database 440. The server now computes the delay that needs to be enforced and stores the delay in a master decision store 445. The delay is then sent back to the clients through a reverse channel.

In one embodiment, when a breakdown between the client 410 and the server 430 is encountered, the client 410 will resort to client throttling algorithms. Consequently, overloaded clients are throttled. Further, whenever a proxy boots up, the proxy synchronizes its local decision store 450 with a nearest master decision store 445 before commencing to serve traffic.

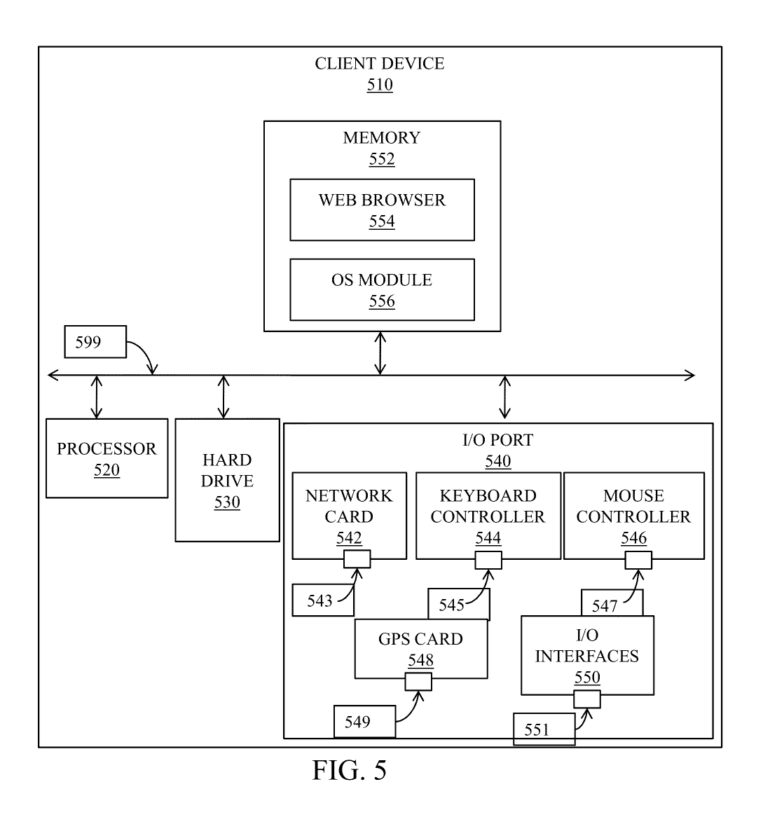

FIG. 5 is a block diagram illustrating an exemplary client device, in accordance with one embodiment.

The client device 510 includes a processor 520, a hard drive 530, an I/O port 540, and a memory 552, coupled by a bus 599.

The bus 599 can be soldered to one or more motherboards. Examples of the processor 520 includes, but is not limited to, a general purpose processor, an application-specific integrated circuit (ASIC), an FPGA (Field Programmable Gate Array), a RISC (Reduced Instruction Set Controller) processor, or an integrated circuit. There can be a single core or multiple cores processor. In one embodiment, the processor 520 is specially suited for processing demands of location-aware reminders (for example, custom micro-code, and instruction fetching, pipelining or cache sizes). The processor 520 can be disposed on silicon or any other suitable material. In operation, the processor 520 can receive and execute instructions and data stored in the memory 552 or the hard drive 530. The hard drive 530 can be a platter-based storage device, a flash drive, an external drive, a persistent memory device, or other types of memory.

The hard drive 530 provides persistent (long term) storage for instructions and data. The I/O port 540 is an input/output panel including a network card 542 with an interface 543, along with a keyboard controller 544, a mouse controller 546, and a GPS card 548. The network card 542 can be, for example, a wired networking card (for example, a USB card, or an IEEE 802.3 card), a wireless networking card (for example, an IEEE 802.11 card, or a Bluetooth card), and a cellular networking card (for example, a 3G card). The interface 543 is configured according to networking compatibility. For example, a wired networking card includes a physical port to plug in a cord, and a wireless networking card includes an antennae. The network card 542 provides access to a communication channel on a network. The keyboard controller 544 can be coupled to a physical port 545 (for example, PS/2 or USB port) for connecting a keyboard. The keyboard can be a standard alphanumeric keyboard with 101 or 104 keys (including alphabetic, numerical and punctuation keys, a space bar, modifier keys, etc.), a laptop or notebook keyboard, a thumb-sized keyboard, a virtual keyboard, or the like. The mouse controller 546 can also be coupled to a physical port 547 (for example, mouse or USB port). The GPS card 538 provides communication to GPS satellites operating in space to receive location data. An antenna 549 provides radio communications (or alternatively, a data port can receive location information from a peripheral device).

The memory 552 can be a RAM (Random Access Memory), a flash memory, a non-persistent memory device, or other devices capable of storing program instructions being executed. The memory 552 comprises of a web browser 554 and an Operating System (OS) module 556. In other embodiments, the memory 552 comprises a calendar application that manages a plurality of appointments. The OS module 556 can be one of Microsoft Windows® family of operating systems (for example, Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64.

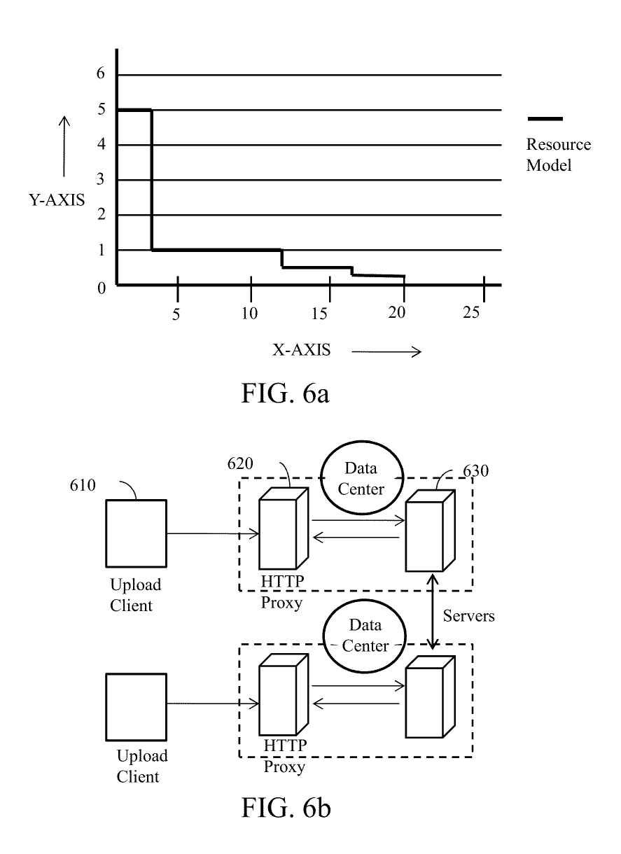

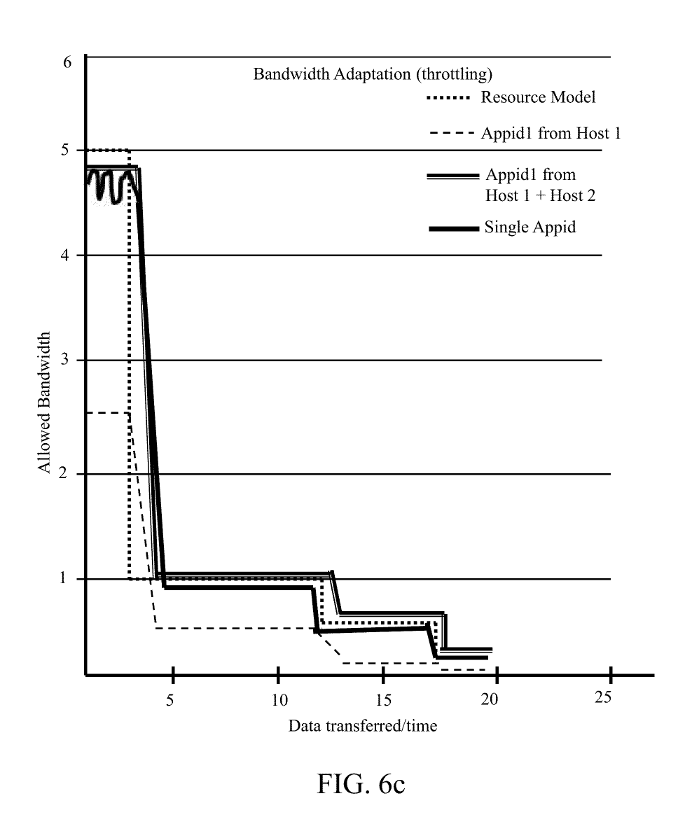

FIGS. 6a, 6b and 6c are exemplary illustrations of throttling a service request from a client.

FIG. 6a represents a resource model indicating permitted bandwidth in the network.

The X-axis represents bandwidth and the Y-axis represents resource.

The graph shows four permitted bandwidth slabs:

a. 0-2 MB: Unlimited Bandwidth

b. 2-12 MB: 1 MBps

c. 12-17 MB: 0.5 MBps

d. 17 MB onwards: 0.25 MBps

FIG. 6b represents an exemplary environment. The environment consists of six hosts across two data centers having one client 610, edge proxy 620 and one server 630 in each of the two data centers. The client associated with colo 1 and colo 2 are identified with AppId 1. Server locations may be referred as colos or data centers.

The delay for an AppId is calculated based on the aggregated network usage information across data centers. Further, rate to be enforced, number of simultaneous connections for the AppId and the time elapsed since the first request required is also calculated. The results are shown in FIG. 6c.

FIG. 6c represents the results based on the resource model in FIG. 6a.

The blue line represents the resource model.

The first result shows an upload from colo1 where a 20 MB file was uploaded.

The red line represents a behavior observed after running a first test.

The second result represents a scenario where two instances of the same appId are initiating a 20 MB upload each to edge proxies in different colos simultaneously.

The green line represents how the client from colo1 was throttled.

The purple line represents the aggregate throttling on appId1 (both clients together).

The highlights of the result are as below:

1. There was a 5-10% decision communication delay.

2. Throttling one client does not affect the other clients.

3. When multiple instances of an appId initiate data transfers simultaneously then the net effect is exactly the same as one instance of that appId uploading the combined data from a single host.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standards 802.11, 802.11a, 802.11b, 802.11e, 802.11g, 802.11i, and 802.11n). In one example, signals from the computer can be transferred, at least in part, wirelessly to components or other computers.

Advantageously, a service provider is enabled with an ability to shape traffic for a service deployed across data centers. As a result, Service Level Agreements (SLAs) can be enforced for a distributed service. Further, the service provider is enabled with an ability to schedule and differentiate client traffic for a service deployed across data centers. Furthermore, traffic shaping and scheduling decisions are made at layer seven. Consequently, business specific parameters are used for traffic shaping, traffic scheduling and SLA decisions.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A computer-implemented method for providing distributed Layer Seven traffic shaping, the computer-implemented method comprising:
receiving one or more service requests from one or more clients, wherein the one or more service requests comprise network usage information associated with the one or more clients;
aggregating the network usage information from the one or more clients across one or more data centers;
computing a delay required for throttling the service request based on data transferred;
communicating the delay to the one or more clients;
throttling the one or more service requests based on the delay across the one or more data centers.

2. The computer-implemented method of claim 1 and further comprising:
extracting the data transferred corresponding to the one or more clients.

3. The computer-implemented method of claim 1, wherein computing the delay is based on the network usage information and the data transferred corresponding to the one or more clients.

4. The computer-implemented method of claim 1, wherein aggregating the network usage information comprises:
storing the network usage information from the one or more clients.

5. The computer-implemented method of claim 1 and further comprising:
storing the delay in a database.

6. The computer-implemented method of claim 1, wherein receiving the one or more service requests comprises:
identifying one or more clients.

7. A computer-implemented method for providing distributed Layer Seven traffic scheduling, the computer-implemented method comprising:
receiving one or more service requests from one or more clients, the one or more service questions includes network usage information associated with the one or more clients;
classifying the network usage information;
selecting a service request from the one or more service requests; and
providing preferential treatment to the service request over the one or more service requests.

8. The computer-implemented method of claim 7, wherein the preferential treatments are one of delay on the service request and prioritizing on the service request.

9. A computer program product stored on a non-transitory computer-readable medium that when executed by a processor, performs a method of providing distributed Layer Seven traffic shaping, comprising:
receiving one or more service requests from one or more clients, wherein the one or more service questions comprise network usage information associated with the one or more clients;
aggregating the network usage information from the one or more clients across one or more data centers;
computing a delay required for throttling the service request based on data transferred;
communicating the delay to the one or more clients;
throttling the one or more service requests based on the delay across the one or more data centers.

10. The computer program product of claim 9 further comprising:
extracting the data transferred corresponding to the one or more clients.

11. The computer program product of claim 9, wherein computing the delay is based on the network usage information and the data transferred corresponding to the one or more clients.

12. The computer program product of claim 9, wherein aggregating the network usage information comprises:
storing the network usage information from the one or more clients.

13. The computer program product of claim 9 and further comprising:
storing the delay in a database.

14. The computer program product of claim 9, wherein receiving the one or more service requests comprises:
identifying one or more clients.

15. A computer program product stored on a non-transitory computer-readable medium that when executed by a processor, performs a method of providing distributed Layer Seven traffic scheduling, the computer program product comprising:
receiving one or more service requests from one or more clients, wherein the one or more service questions comprise network usage information associated with the one or more clients;
classifying the network usage information;
selecting a service request from the one or more service requests; and
providing preferential treatment to the service request over the one or more service requests.

16. The computer program product of claim 15, wherein the preferential treatment is one of a delay on the service request and prioritizing on the service request.

17. A system for providing distributed Layer Seven traffic shaping and traffic scheduling, the system comprising:
a plurality of server devices that receives one or more service requests and that computes a delay required for throttling a service request;
a plurality of client devices in electronic communication with the server devices; and
a resource usage database, communicatively coupled to the user interface that stores network usage information of the plurality of client devices.

18. The system of claim 17, wherein the server device aggregates the network usage information from the one or more clients across one or more data centers and computes a delay required for throttling the service request.

19. The system of claim 17, wherein the server devices communicate with each other enabling a distributed environment.

20. The system of claim 17, wherein the server further comprises:
a master decision store that stores the delay required for throttling a service request.
